(19) United States
(12) Patent Application Publication
(10) Pub. No.: US 2026/0267304 A1
(43) Pub. Date: Sep. 10, 2026

(54) SYSTEM AND METHOD FOR PROVIDING INTELLIGENT POWER DISTRIBUTION AND PRIORITIZATION

(71) Applicant: Universal Electronics Inc., Scottsdale, AZ (US)

(72) Inventors: Vatsala Dwivedi, Bangalore (IN); Bhuvanesh Prabhu, Bangalore (IN); Arsham Hatambeiki, San Francisco, CA (US)

(21) Appl. No.: 19/071,142

(22) Filed: Mar. 5, 2025

(51) Int. Cl. G05B 19/04; G05B 19/045; G05B 19/05

(52) U.S. Cl. CPC G05B 19/041; G05B 19/045; G05B 19/054; G05B 19/058; G05B 2219/2642

(57) ABSTRACT

A smart inverter stores in a memory a first data, each of which is cross-referenced to a one of a plurality of appliances detected within an environment, and a second data that is cross-referenced to at least one user of the plurality of appliances. The smart inverter then uses first communications received from the plurality of appliances, second communications, received from one or more sensors provided to track at least a presence of the user, the first plurality of data, and the second data to determine, and store in memory as third data, at least a time when the at least one user interacts with each of the plurality of appliances. In response to a power outage event, the smart inverter uses the third data to cause a one of the plurality of appliances to be turned or kept on.

### BACKGROUND

As known in the art, an inverter is a device that helps in converting direct current electricity into alternate current electricity. Inverters are mainly used as a source of power to run appliances and devices when there are power cuts. When the main electricity supply goes down, inverters will continue to provide electricity to the device and appliances used in the home (referred to hereinafter as “appliances”). However, by simply continuing to provide electricity to the appliances, the inverter battery may quickly drain which, in turn, may undesirably reduce the backup operational time of the appliances.

### SUMMARY

To address this and other problems, the following describes system and method for providing intelligent power distribution and prioritization. In an example, the system comprises a smart inverter and the smart inverter stores in a memory a first data, each of which is cross-referenced to a one of a plurality of appliances detected within an environment, and a second data that is cross-referenced to at least one user of the plurality of appliances. The smart inverter then uses first communications received from the plurality of appliances, second communications, received from one or more sensors provided to track at least a presence of the user, the first plurality of data, and the second data to determine, and store in memory as third data, at least a time when the at least one user interacts with each of the plurality of appliances. In response to a power outage event, the smart inverter will use the third data to cause a one of the plurality of appliances to be turned or kept on.\

A better understanding of the objects, advantages, features, properties and relationships of the claimed invention will be obtained from the following detailed description and accompanying drawings which set forth illustrative embodiments and which are indicative of the various ways in which the principles of the claimed invention may be employed.

### BRIEF DESCRIPTION OF THE DRAWINGS

For a better understanding of the various aspects of the systems and methods described hereinafter, reference may be had to the attached drawings in which:

FIG. 1 illustrates an example system having a smart inverter; and

FIG. 2 illustrates an example method for using the smart inverter to control an operation of an appliance during a power outage event.

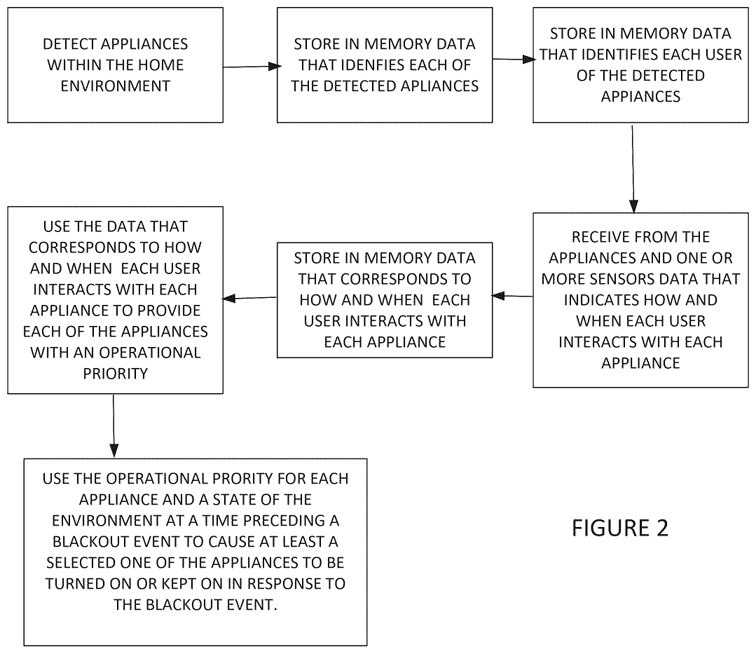

### DETAILED DESCRIPTION

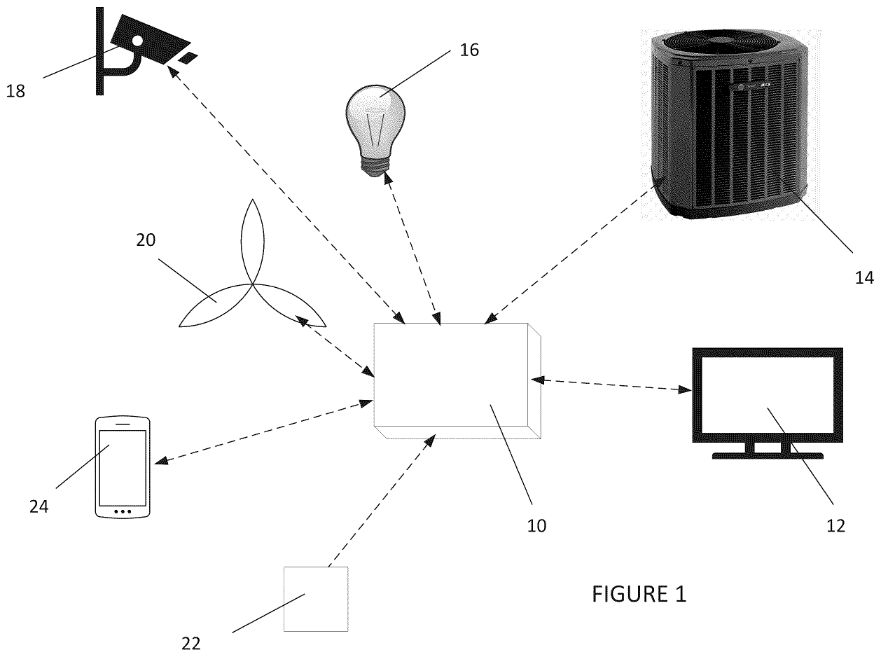

A smart inverter is designed to increase the backup running time of appliances and save energy. To this end, the smart inverter 10 will be adapted to detect and/or register connected appliances, such as a television 12, a fan 20, a light 16, a camera 18, an HVAC system 14, and like that are within a home environment as shown in FIG. 1. The smart inverter 10 includes or is associated with a controlling device that will function to control one or more of the home appliances that have been detected and/or registered with the system. In addition to controlling the connected appliances, the controlling device included with or associated with the smart inverter 10 may also receive state information from sensors 22, such as temperature sensors, motion sensors, security sensors, and the like, a cell phone 24 of one or more users, and the appliances. As described hereinafter, this state information will be used to train the smart inverter 10 and to allow the smart inverter 10 to make decisions based upon a state of the environment when a power cut event occurs.

To detect and/or register the connected appliances, the smart inverter 10 (or a device communicatively coupled to the smart inverter 10) may utilize one or more of the methods described in U.S. application Ser. No. 19/006,976, filed on Dec. 31, 2024 (hereinafter “the '976 application”), which application is incorporated herein by reference in its entirety. In addition to detecting and registering connected appliances within the home, the smart inverter 10 may respond to a loss of power event by switching off those of the detected and/or registered connected devices that are designated as being not a priority to operate during a power cut and/or those that are not in active use, e.g., those that are not being operated/interacted with by a user at the time of power loss. The smart inverter 10 may also use priorities associated with the appliances to cause one or more appliances to be turned on. The controlling of the operational state of the appliances, e.g., to turn on or off an appliance, will also be performed as described in the '976 application, e.g., by configuring a controlling device within or communicatively coupled to the smart inverter 10 with protocols and commands needed to control functional operations of controllable appliances.

As concerns determining whether an appliance is actively in use (or may need to be in use) the smart invertor 10, using one or more of the methods described in the '976 application, will also be adapted to detect person(s) within or without the home. The smart inverter 10 can further be adapted to determine locations of persons within the home, movement of persons within the home, and the like as also described in the '976 application. The smart inverter 10 may then be adapted to respond to a loss of power by switching off those appliances that are designated as not being a priority to operate during a power cut when it is determined that one or more person(s) are not home and/or to turn or keep on/operate those appliances that are in use or typically in use by the person(s) in the home when it is determined that those people are at home.

To facilitate the control of appliances based upon times of interactions with the appliances by one or more persons and/or locations/movements of persons relative to the appliances while the appliances are in use, the smart inverter 10 may again use one or more of the methods described in the '976 application. The interaction and person tracking histories may be utilized by the smart inverter 10 to automatically generate, and adjust as desired, a priority level assigned to an appliance. Specifically, with appliance and person data categorized as described in the '976 application, operational priorities can be assigned to the appliances (and adjusted as needed). The use of the categories will particularly allow the priorities to vary based on the times of day, week, month, and/or year, presence, locations, and/or movement of persons within the home, etc. As will thus be appreciated, a decision whether to turn on or off appliances response to a power cut may be based upon the priorities that are assigned to the appliances for the given state of the home/appliances at the time of power cut, the given state of tracked persons at the time of power cut, and/or the time of power cut, i.e., a state of the environment, Furthermore, after the power cut, the decisions as to whether to turn on or off appliances can be updated and corresponding actions can take place based upon any changes in the state of the appliances, state of the persons, and/or the state of power (e.g., the inverter battery state or the restoration of external power). For example, appliances can be automatically turned on or off by the smart inverter as persons enter or leave the home, as the time-of-day changes, as feedback is received from environmental sensors, when power is restored, etc.

In keeping with the above, it is seen that the capturing of appliance usage information, person information, environmental information, and the like and the categorizing of such captured information may be used to train the smart inverter 10. In other words, the smart inverter 10 is adapted to learn, e.g., via use of self-supervised learning algorithm, user requirements during different home states and to control the appliances using the priorities that are associated with such states during a power cut.

In summary and as shown in FIG. 1, the subject smart inverter generally operates to detect each of a plurality of appliances in a home environment, to store in a memory associated with the smart inverter a plurality of first data each of which is cross-referenced to a one of the plurality of appliances, to store in the memory a second data that is cross-referenced to at least one user of the plurality of appliances, determine from use of first communications received from the plurality of appliances, second communications, received from one or more sensors and/or a cell phone linked to a user, having data that is usable to at least track a presence of the at least one user within the environment, the first plurality of data, and the second data at least a time when the at least one user interacts with each of the plurality of appliances, store in the memory a third plurality of data that specifies at least when the one or more users turns on and turns off each one of the plurality of appliances, and use third plurality of data to assign an operating priority to each of the plurality of appliances whereupon the third plurality of data will be used in the event of a power outage to cause at least a select one of the plurality of appliances to be turned or kept on.

To further assist in an understating of the subject smart inverter 10, example use cases are now described.

In a first use case, upon an occurrence of a power cut, if a high intensity appliance is currently in use, such as a coffee maker, grinder, toaster, hair dryer, or the like, and the appliance is connected with the smart inverter 10 (meaning it has been automatically detected and registered with the smart inverter 10), the smart inverter 10 may function to automatically provide power to that specific appliance, based on its priority, and the power may be provided for a certain duration of time, for example a time needed to complete a current task such as 10 minutes.

In a second use case, if two appliances are active and a power cut occurs, the smart inverter 10 can continue to provide power to one of appliances, i.e., the appliance with the higher operational priority given the determined home state, while switching off the other appliance. Thus, if both a grinder and a toaster are active when a power cut occurs, the smart inverter 10 may determine, using the priorities assigned to the appliances concerning the home state, that the grinder will switch off and that the toaster will get an uninterrupted power supply for at least a set amount of time (or until it is by the smart inverter that the draw of power has decreased meaning that the toast is done). In some instances, when the state changes in this manner, i.e., the state changes to indicate that the toaster is no longer in use and as such, the priority of the toaster is lessened, the priority of the grinder may become sufficiently large relative to the other appliances such that the smart inverter may cause power to be provided to the grinder. As described below, the priority assigned to each appliance may, for example, reflect a prior usage of the appliances by one or more persons during a previous power cut at or around the same time and day or week.

In a still further use case, when the smart inverter 10 determines from the information provided to the smart inverter 10 that no persons are present within the home, the smart inverter 10 may, responsive to a power cut and this determined state, cause all “non-essential” devices to be powered off (this can be set by a user) and provide power only to required device, such as an IP/CCTV Camera 18.

In a yet further use case, the information provided to the smart inverter 10 from the TV 12, one or more sensors 22 or cell phones 24, etc., indicates to the smart inverter 10 that people are watching TV in the living room and a power cut occurs during that time, the system may respond considering that state information. For example, if the system is also informed that lights are on in the bedroom or kitchen, the smart inverter 10 may respond to the power cut and use the priorities associated with this state by automatically switching off all lights in all rooms except in the living room while continuing to provide power to TV 12. Similarly, if a power cut occurs later in the evening at time when persons within the home are sleeping, the smart inverter 10 will use the priorities associated with this state to cause all lights left on to be switched off, and cause a bedroom fan 20, if off, to be turned on. When power is resumed, the smart inverter 10 may then automatically cause the fan 20 to be turned back off since the air conditioner (which may not be connected to the inverter considering it is a high Intensity device) will work.

In some instances, the system will allow a user to set the actions to be taken upon a power cut, to adjust priorities that have been established by the system by use of machine learning, to monitor appliance usage during a power cut, and/or the like. by using a smart inverter companion app installed on a cell phone 24. As will be appreciated, a user may use the app to establish or adjust (generally or for a given state) which appliance(s) have the highest priority to be on, which appliance(s) have priority to possible by turned on if a current state of the system permits such action, which appliance(s) have the lowest priority and should be switched off, how long any specific appliance should be kept on, how long any appliance could be turned off, etc.

As noted above, the smart inverter 10 will learn to tune its actions with respect to controlling appliances during a power cut. In some instances, the behavior taken can simply be reflective of a behavior that occurred during a previous power cut. For example, if a power cut occurs during a time while person(s) in the home are asleep and it is detected that a person who is sleeping in a given room has gotten up after some time and switched on a fan 20, this may indicate to the smart inverter 10 that, when there is power cut during the night, a person needs the fan 20 operational when the air conditioner is not working. This behavior of the user will be learned by the smart inverter 10 and, based on this self-training, the next time a power cut occurs during the night, the smart inverter 10 will automatically cause the fan 20 to be switched on when the AC is detected as being off. If, however, the next power cut occurs during the day, the smart inverter 10 will not automatically switch on the fan 20 since the person in the home never switched on the fan 20 during the day. The smart inverter 10 may also use this learned behavior to switch on the fan 20 during other times having similar states, such as on a weekend, when a person is determined to be home and sleeping during an afternoon or spending time in the bedroom during a certain time of time of day.

In a further example, to prevent a bad actor from overloading an electrical grid by remotely causing a thermostat or a controlling device, such as one associated with the smart inverter, to turn on high intensity appliances, such as a furnace or an air conditioning unit, it may be required for the thermostat or the controlling device to validate the command before performing the action. The validation may take the form of contacting a user for confirmation, validating the command as coming from a trusted source, such as by using a private key infrastructure messaging system, or the like.

More particularly, to prevent a regional, synchronized attack on an electrical grid, the system may utilize an authenticated clearing cloud services to create multiple layers of defense, including robust authentication, anomaly detection, geographic restrictions, and regional redundancy. The measures will make it much harder for attackers to execute a synchronized attack across multiple regions, as they would need to bypass numerous security protocols in different areas of the cloud infrastructure. To this end, the system may employ one or more of a strong authentication mechanism, a geolocation and/or IP address restriction, activity monitoring and anomaly detection, distributed denial-of-service (DDoS) protection, a decentralized system, an audit log and forensic tool, and secure APIs.

Examples of strong authentication mechanisms that can be utilized individually or in combination include Multi-Factor Authentication (MFA) and Role-Based Access Control (RBAC). By requiring more than just a password (e.g., biometrics, OTP, or hardware tokens), a MFA cloud services can ensure that only authorized personnel can access the system. This helps prevent unauthorized users from initiating attacks, especially if the attacker is attempting to access accounts regionally. With RBAC, access is restricted based on the user's role in the organization, ensuring that users will only have the necessary permissions to perform their tasks. This reduces the potential impact of an attack, especially in a synchronized manner.

As to geolocation and IP address restrictions, the system may monitor login attempts. If login attempts originate from unexpected locations or multiple regions simultaneously, the system can trigger an alert that indicates an attack. Security measures can then be enacted to block these logins thereby preventing synchronized attacks across regions. Similarly, IP whitelisting can be used to restrict which IP addresses are allowed to access the system, thereby preventing unauthorized access from malicious sources.

Activity monitoring and anomaly detection involves the use of machine learning algorithms to help in detecting unusual or synchronized activity across regions. For example, if there is a sudden surge of requests or commands that seem to be coming from various regions at the same time, it could indicate a coordinated attack. In such cases, the system can automatically trigger alerts or defensive actions to mitigate potential damage as described above. For this purpose, the system may additionally or alternatively employ behavioral analytics: This technology helps to establish a baseline for normal activity and identifies any anomalies or deviations from typical patterns. If an attack is launched from multiple regions simultaneously, it can be flagged as suspicious and acted upon before it escalates.

With respect to distributed denial-of-service (DDoS) protection, if an attacker tries to flood multiple regions with a DDoS attack in a synchronized manner, the system can leverage existing advanced DDoS protection mechanisms that can identify and mitigate attack attempts. These protections can absorb the traffic and maintain the availability of services.

To address regional, synchronized attacks, the system can be decentralized, the system can distribute critical data and services using cloud servers located across multiple regions or availability zones. This means that even if an attacker manages to compromise one region, the data or services remain available from other regions, making it harder for the attack to succeed. Geo-replication will also ensure that data is synchronized across regions, so even if an attack impacts one region, the others remain unaffected and can continue operating.

Unusual activity can also be tracked and mitigated by maintaining secure, immutable audit logs of all access and activity. This is crucial when trying to identify and respond to coordinated regional attacks. Detailed logs allow administrators to trace the origins of an attack, even if it spans multiple regions.

To ensure that only valid requests can interact with the cloud infrastructure of the system, the system may provide secure APIs. Secure APIs are APIs with authentication tokens or keys. Attackers attempting to send synchronized API requests across regions would need to bypass the authentication, which is a significant barrier.

While various concepts have been described in detail, it will be appreciated by those skilled in the art that various modifications and alternatives to those concepts could be developed in light of the overall teachings of the disclosure. For example, while the exemplary methods are presented above in the context of a home system, it will be appreciated that the principles disclosed herein may be broadly applied to, for example, offices, factories, theaters, department stores, shopping malls, airports, etc. In addition, it is to be appreciated that the steps described herein need not be performed in the exact order described and, as such, the steps can be practiced in any order as will provide the desired result of controlling one or more appliances during a power outage event.

Further, while described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

All patents cited within this document are hereby incorporated by reference in their entirety.

What is claimed is:

1. A method, performed by a smart inverter, for controlling an operation of a one of a plurality of appliances within a home environment during a first power outage event, comprising:
detecting the plurality of appliances;
storing in a memory associated with the smart inverter a plurality of first data each of which is cross-referenced to a one of the plurality of appliances;
storing in the memory a second data that is cross-referenced to at least one user of the plurality of appliances;
determining from use of first communications received from the plurality of appliances, second communications, received from one or more sensors, having data that is usable to at least track a presence of the at least one user within the environment, the first plurality of data, and the second data at least a time when the at least one user interacts with each of the plurality of appliances;
storing in the memory a third plurality of data that specifies at least when the one or more users turns on and turns off each one of the plurality of appliances;
using the third plurality of data to assign an operating priority to each of the plurality of appliances; and
in response to the first power outage event, using the third plurality of data to cause the one of the plurality of appliances to be turned or kept on.

2. The method as recited in claim 1, comprising configuring the smart inverter with a plurality of command code sets each associated with a one of the plurality of appliances and each having command data transmittable using one or more communication protocols that are recognizable by respective ones of the plurality of appliances.

3. The method as recited in claim 1, wherein the plurality of command codes sets are received from a server in response to providing to the server the first data.

4. The method as recited in claim 1, wherein the time when the at least one user interacts with each of the plurality of appliances occurs during a second power outage event which precedes the first power outage event.

5. The method as recited in claim 1, wherein the one or more sensors comprises a cellular phone.

6. The method as recited in claim 1, wherein the second communications further comprises data further that is usable to at least track a direction of movement of the at least one user within the environment.

7. The method as recited in claim 1, wherein the first communication comprise data that indicates a state of the plurality of appliances preceding the power outage event.

8. A non-transitory, computer-readable media having stored thereon instructions, wherein the instructions, when executed by a smart inverter, cause the smart inverter to perform steps for controlling an operation of a one of a plurality of appliances within a home environment during a first power outage event, the steps comprising:
detecting the plurality of appliances;
storing in a memory associated with the smart inverter a plurality of first data each of which is cross-referenced to a one of the plurality of appliances;
storing in the memory a second data that is cross-referenced to at least one user of the plurality of appliances;
determining from use of first communications received from the plurality of appliances, second communications, received from one or more sensors, having data that is usable to at least track a presence of the at least one user within the environment, the first plurality of data, and the second data at least a time when the at least one user interacts with each of the plurality of appliances;
storing in the memory a third plurality of data that specifies at least when the one or more users turns on and turns off each one of the plurality of appliances;
using the third plurality of data to assign an operating priority to each of the plurality of appliances; and
in response to the first power outage event, using the third plurality of data to cause a one of the plurality of appliances to be turned or kept on.

9. The non-transitory, computer-readable media as recited in claim 8, where in the steps further comprise configuring the smart inverter with a plurality of command code sets each associated with a one of the plurality of appliances and each having command data transmittable using one or more communication protocols that are recognizable by respective ones of the plurality of appliances.

10. The non-transitory, computer-readable media as recited in claim 8, wherein the plurality of command codes sets are received from a server in response to providing to the server the first data.

11. The non-transitory, computer-readable media as recited in claim 8, wherein the time when the at least one user interacts with each of the plurality of appliances occurs during a second power outage event which precedes the first power outage event.

12. The non-transitory, computer-readable media as recited in claim 8, wherein the one or more sensors comprises a cellular phone.

13. The non-transitory, computer-readable media as recited in claim 8, wherein the second communications further comprises data further that is usable to at least track a direction of movement of the at least one user within the environment.

14. The non-transitory, computer-readable media as recited in claim 8, wherein the first communication comprise data that indicates a state of the plurality of appliances preceding the power outage event.
